(19) United States
(12) Patent Application Publication
(10) Pub. No.: US 2013/0092787 A1
(43) Pub. Date: Apr. 18, 2013

(54) Means to improve the performance of high energy brakes such as in aircraft landing gear.

(71) Applicant: Michal Polubinski, Mississauga (CA)

(72) Inventor: Michal Polubinski, Mississauga (CA)

(21) Appl. No.: 13/621,844

(22) Filed: Sep. 17, 2012

Related U.S. Application Data
(63) Continuation of application No. 61/535,717, filed on Sep. 16, 2011.

(51) Int. Cl. B64C 25/42; F16D 65/78; B64C 25/00

(52) U.S. Cl. CPC B64C 25/42; B64C 25/001; F16D 65/78
USPC 244/50; 188/264 D

(57) ABSTRACT

The invention provides means to prevent high-performance brakes from overheating by delivering coolant to the heat-generating brake components. As a result of implementing the invention, the brakes can then be used more effectively to control an aircraft during aborted landing after touchdown. After the aircraft completed the braking action, the risk of damaging tire explosions and undercarriage fires is minimized. The aircraft does not require an extensive post-incident overhaul and can be back in service much faster than when and if the invention is not implemented.

Another component of the invention reduces the wear and tear of aircraft tires by providing self-propelled rotation before touchdown.

### TITLE OF INVENTION

Means to improve the performance of high energy brakes such as in aircraft landing gear.

This invention claims priority of application Ser. No. 61/535,717

### TECHNICAL FIELD

The invention is best used in high-performance mechanical brakes such as in the undercarriage of commercial aircraft.

### PRIOR ART

High-performance brakes for heavy equipment use carbon-based friction material as a major component of brake stacks such as shown in

are used as components of a landing gear of aircraft. During a typical deceleration, the brakes may have to dissipate as much as 1GJ of energy (Boeing 7474-8I) (Boeing, 2008) in 30 seconds. Using prior art technology results in heating of brake assemblies to as much as 3,000° C. leading to tire blowouts (if not equipped with safety fuses) and to the fires in the undercarriage.

### TECHNICAL PROBLEM

One of the most destructive effects of deceleration is experienced during aborted take-off of airplanes is caused by the heat dissipated in the undercarriage (avvideos, 2007)

Before being allowed to operate in the airspace, an airplane must undergo a battery of tests, as required by aviation authorities. A rejected takeoff (RTO) test is normally performed only if the aircraft's speed is below the takeoff decision speed known as “V₁ speed, (Anonymous, 2008) (Definitions and Usage Notes, 2011). During the test, the airplane should be able to stop safely before the end of the runway. As the result of heavy deceleration, the brakes can reach the temperature of 3,000° C., resulting usually in the extensive damage to the undercarriage and to the underbody of the airplane. The cost of damages can be as much as USD 750,000 in 2011 prices.

The damage caused by overheated brakes and the undercarriage as the result of an emergency rejected takeoff can be more severe.

In normal operation,

“Stators and rotors, thermally loaded at contact surfaces, deform taking the quasi-barrel-shape in the axial cross-section plane. This deformation induces the loss of contact in the outer areas of the initial contact surface and correspondingly increased load in the center.”i

The absence of efficient cooling mechanism for the aircraft brakes calls for the following solutions:

“If it is considered or suspected that the brakes (and therefore the adjacent tires) may be unduly hot after take-off, then the following precautions may be prudent in order to allow the components time to cool:
Leave the gear down for an extended period after take-off having considered any effect this will have on climb performance.
If at all possible, avoid making a landing very soon after take-off.
Follow the AFM limitations for minimum ground cooling periods after heavy braking. This would especially apply after a high speed Rejected Take Off.
Always consider whether Hot Brake incidents should be attended by fire crews.
Confine all significant braking to times when the aircraft is travelling in a straight line to avoid tyre stress and undue wear
Ensure that brakes are never applied against forward thrust or power while the aircraft is moving.
Avoid high power settings against the brakes while the aircraft is stopped unless conducting required checks or procedures such as an engine runup.
Do not inadvertently ‘ride’ the toe brakes whilst taxyingii

“Carbon brake oxidation. Over the last 20 years, airlines have moved from steel to carbon brakes to reduce aircraft weight. Contamination from potassium can result in catalytic oxidation and subsequent carbon degradation in aircraft brakes. “Deicer fluid seeps in and works its way into the carbon on a microscopic level,” Duncan explains. “As the brakes heat up, it generates a catalytic reaction causing hard carbon disc material to crumble. You cannot predict when this is going to happen. It proceeds quickly and can happen within a few flights.”

The corrosion is a serious safety concern, because braking effectiveness is reduced as carbon breaks down, stresses Kelvin Williamson, North American president at Basic Solutions. “Pilots may not get the braking performance they expect,” Williamson explains. “If an aircraft does a rejected takeoff, the plane may end up going off the runway.”
Brake parts can actually fly off the aircraft and puncture aircraft wings, engines or other areas, he cautions. Carbon disc debris left on runways, taxiways or ramp areas can damage other aircraft. Airlines have stepped up maintenance intervals to address these problems, he adds, but the extra service comes at a high price—up to $5 million more per year for some airlines. Industrywide estimates, Williamson reports, are as high as $75 million.”iii

### SOLUTION TO THE PROBLEM

The invention provides the means to transfer heat generated in brake systems from the heat-generating zones (typically interface between rotating carbon discs and static calipers) to the environment. The heat energy is used to heat up the coolant to the boiling point and then to evaporate the coolant. In one of the embodiments potable and lavatories' water is used as the coolant during the rejected takeoff air flight phase. Typically, the water and fuel tanks are filled to the capacity required to complete the planned flight. This means that the cooling capability (proportional to the mass of water in the tanks) is in tune with the demand to dissipate the kinetic energy (proportional to the overall mass) of an airplane.

To overcome a risk of freezing of a coolant in the coolant piping, in the initial phase of operation, liquid antifreeze is injected into the piping, or a suitable mixture of the antifreeze and the coolant. Eventually, when the piping reaches a temperature above the freezing point of the coolant the risk of freezing is eliminated.

Another means to improve touchdown phase of the flight involve attaching wind turbines with cup-shaped vanes to the landing gear wheels. When wheels come into contact with the airstrip surface, they are self-propelled to minimize the scrubbing and overheating of tires.

Water is the most preferred choice on passenger carrying airplanes for many reasons:

Water is readily available on a passenger aircraft during take-off. The recommended location of water tanks is in the proximity of landing gear.
The capacity to absorb heat from room temperature (20° C.) to evaporation (2590 kJ/kg)^{iv v} is one of the highest of all liquids readily available on an aircraft.

Sodium acetate trihydrate (NaAc.3H₂O, or CH₃COONa.3H₂O, or C₂H₃NaO₂.3H₂O)^{vi vii}is one of the antifreezing substances which can be selected for this application. It's specific heat is around 6.8 kJ/kgK, the enthalpy of melting is 263 kJ/kg^{viii}. As a solid, it may be combustible at auto-ignition temperature of 607.22°. However, to extinguish the fire it is recommended to use water spray, fog or foam; water jet should not be used.^{ix}. If it is pre-mixed with water—as it should be—and applied to cool the brakes, the mixture will turn into fog or foam, thus extinguishing a potential fire.

Anhydrous sodium acetate (NaAc, or CH₃COONa, or C₂H₃NaO₂) may be considered as another antifreeze additive.

Some sodium acetate-based commercially developed anti-freezing products are certified for aircraft use, such as Cryotech BX36^{x}, which, according to the manufacturer: “Improves carbon brake compatibility by reducing catalytic oxidation (AIR 5567^{xi})”. If this product is selected as antifreeze, a consideration should be given to compatibility with water piping leading to brake assemblies.

In general, the heat capacity of sodium acetates is lower than that of water; therefore it is recommended that antifreezes are used as needed, i.e. when the air temperature around the landing gear is below 0° C. and only when the piping is primed with a coolant. After the piping is warmed up by passing water-antifreeze mix, the inflow of antifreeze should be cut-off.

It is assumed that normal equipment inspection is performed after a rejected take-off incident, or that the brake components are replaced after RTO test.

### ADVANTAGEOUS EFFECTS OF INVENTION

The invention will result in improvement of safety, reliability, reduction of costs and marketability of air travel and of airplanes.

The invention reduces the maximum temperature of airplane brakes during intensive deceleration. The risk of failure of brakes equipped with the invented means is significantly diminished. The brakes can then be used more effectively to control an aircraft during aborted landing after touchdown. After the aircraft completed the braking action, the risk of damaging tire explosions and undercarriage fires is minimized. The aircraft does not require an extensive post-incident overhaul and can be back in service much faster than when and if the invention is not implemented.

As a part of RTO test protocol, firefighters approach the usually-burning undercarriage five minutes after an airplane comes to a full stop. The working environment is not very healthy. Smoke, exploding tires and red hot brakes are not synonymous with a safe working environment. A hot undercarriage has not collapsed so far. The absence of fires after aborted takeoff will positively affect the perception of air transport's safety and reliability.

The health effects of dust emanating from brakes are unknown^{xii}. Nevertheless, is anticipated that high performance brakes equipped with a cooling system as described in this invention should emit less dust than the prior art brakes.

The placement of cup-shaped vanes (wind turbine) on landing gear wheels results in less tire scrubbing and burnout during the touchdown of an aircraft. During the touch down the self-propelled wheels rotate in such a manner that the linear speed of tires at the touchdown points is greater than zero. As a side effect of the placement of vanes, the undercarriage provides additional wind resistance.

### BRIEF DESCRIPTION OF DRAWINGS

FIG. 1 Coolant Flow

This figure is for illustration purposes only. The detailed design will depend on a particular brake model, requirements, and design goals.

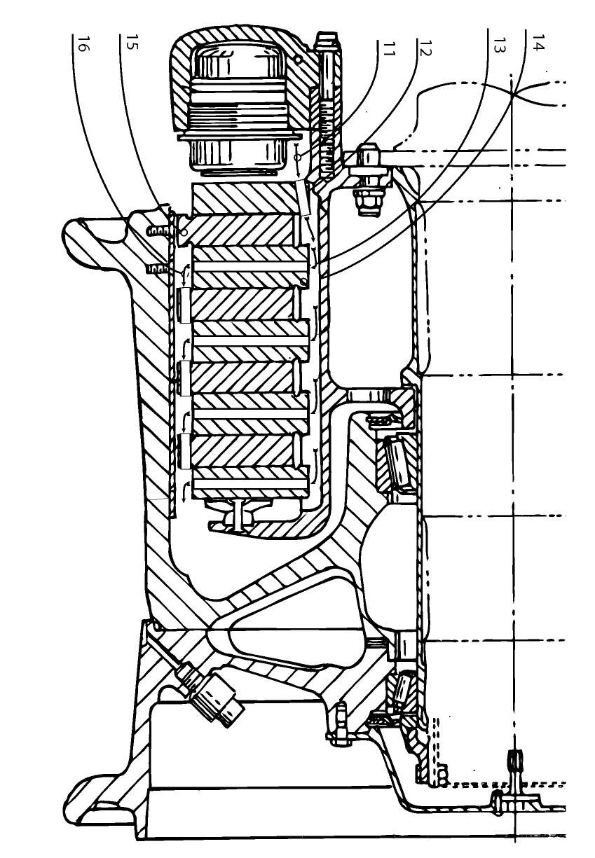

In FIG. 1 the coolant flows is indicated by arrow (11) through an opening (12) to a channel (13) in stator (14). The hot coolant exits at (15) to an opening (16) in a rotor.

### INDUSTRIAL APPLICABILITY

The invention can be advantageously used in airplanes, performance cars, elevators, cranes, heavy equipment, rail transport, military transport, etc.

The feasibility of using water as a coolant has been evaluated in case of two airplanes: Boeing 747 Intercontinental and Airbus A380-800. In both cases the kinetic energy at V1 (V1 means the maximum speed in the takeoff at which the pilot must take the first action (e.g., apply brakes, reduce thrust, deploy speed brakes) to stop the airplane within the accelerate-stop distance. V1 also means the minimum speed in the takeoff, following a failure of the critical engine at VEF, at which the pilot can continue the takeoff and achieve the required height above the takeoff surface within the takeoff distance.)xiii of 66.7 and 85.4xiv m/s.

The cooling water required to absorb 100% of airplane's kinetic energy at 100% efficiency would be approximately 380 and 810 kg. In the standard configuration, water tank capacities are correspondingly 2390 and 1700 I. The free-flow of water at 1 m/s would require 16 pipes of 3.8 cm (1.5 inch) I.D. leading to each of 16 braked wheels^{xv} in each case.

### NON PATENT LITERATURE

Phase of Flight. (2011, May). Retrieved Sep. 14, 2011, from Civil Aviation Organization (ICAO) and the Commercial Aviation Safety Team (CAST): http://intlaviationstandards.org/Documents/PhaseofFlightDefinitions.pdf
American National Standards Institute. (2009). SAE AIR 5567-2009 (SAE AIR5567-2009). Retrieved Sep. 14, 2012, from eStandards Store: http://webstore.ansi.org/RecordDetaiLaspx?sku=SAE+AIR+5567−2009+(SAE+AIR5567-2009)#.UFPz6o1IRRw
Anonymous. (2008, November). Rejected takeoff. Retrieved Sep. 14, 2011, from Wikipedia: http://en.wikipedia.org/wiki/Rejected_takeoff
avvideos. (Oct. 26, 2007). Boeing 777 rejected take off (RTO). Retrieved Sep. 14, 2011, from YouTube: http://www.youtube.com/user/avvideos
Boeing. (2008, September). 747-8 Airplane Characteristics for Airport Planning. Retrieved Sep. 14, 2011, from Boeing: http://www.boeing.com/commercial/airports/acaps/747_{—}8.pdf
Chemspider. (n.d.). CSID:21110, http://www.chemspider.com/Chemical-Structure.21110.html (accessed 23:16, Sep. 14, 2012). Retrieved Sep. 14, 2012, from Chemspider: http://www.chemspidercom/Chemical-Structure.21110.html
Cryotech. (Oct. 11, 2011). CRYOTECH BX36, Bio-Based Liquid Runway Deicer, AMS 1435 Certified. Retrieved Sep. 14, 2012, from Cryotech: http://www.cryotech.com/products/pdf/bx36_fs.pdf
Electronic Code of Federal Regulations. (Sep. 12, 2012). Title 14: Aeronautics and Space. Retrieved Sep. 16, 2012, from Electronic Code of Federal Regulations: http://ecfr.gpoaccess.gov/cgi/t/text/text-idx?c=ecfr;sid=c2d90aaaf3558c7b326df06c7823b1f5;rgn=div5;view=text;node=14%3A1.0.1.1.1;idno=14;cc=ecfr
Garrett, R. (2010, 07-08). Bio-based Deicers Avoid Corrosion Linked to Potassium Acetate & Formate. Retrieved Jun. 13, 2012, from Airportimprovement: http://www.airportimprovement.com/content/story.php?article=00194
Hebborn, A. (Jun. 5, 2008). A380 Landing Gear and Systems—The feet of the Plane. Retrieved Sep. 16, 2012, from Hochschule für Angewandte Wissenschaften Hamburg: http://www.fzt.haw-hamburg.de/pers/Scholz/dglr/hh/text_{—}2008_{—}06₁₃ 05_LandingGear.pdf http://www.youtube.com/user/avvideos. (Oct. 26, 2007). Boeing 777 rejected take off (RTO). (http://www.youtube.com/watch?v=wXpjBxD0Rhg, Producer, & avvideos) Retrieved Sep. 14, 2011, from YouTube: http://www.youtube.com/watch?v=wXpjBxD0Rhg
Kingsley-Jones, M. (Mar. 13, 2007). The Airbus A380 Thread. Retrieved Sep. 16, 2012, from iflyafrica.com: http://www.flyafrica.info/forums/showthread.php?73-***-The-Airbus-A380-Thread-***/page9
Multiple. (Jun. 18, 2008). Carbon Brake Dust-Airbus. Retrieved Sep. 15, 2012, from The Professional Pilots Rumor Network: http://www.pprune.org/archive/index.php/t-331492.html
ScienceLab.com. (Sep. 6, 2012). Material Safety Data Sheet, Sodium acetate trihydrate MSDS. Retrieved Sep. 12, 2012, from ScienceLab.com: http://www.sciencelab.com/msds.php?msdsld=9927412
Skybrary. (n.d.). Brakes. Retrieved Sep. 12, 2012, from Skybrary: http://www.skybrary.aero/index.php/Brakes
VLADIMÍR VÍCHA, P. F. (n.d.). Physics teachers' inventions fair 11. Retrieved from Department of Physics Education, Faculty of Mathematics and Physics,.
Wikipedia. (n.d.). Enthalpy of vaporization. Retrieved Sep. 13, 2012, from Wikipedia: http://en.wikipedia.org/wiki/Enthalpy_of_vaporization
Wikipedia. (n.d.). Heat capacity. Retrieved Sep. 13, 2012, from Wikipedia: http://en.wikipedia.org/wiki/Heat_capacity
Wikipedia. (n.d.). Sodium acetate. Retrieved Sep. 12, 2012, from Wikipedia: http://en.wikipedia.org/wiki/Sodium_acetate
Zbigniew Wolejsza, A. D. (2002). Thermo-Mechanical Analysis of Airplane Carbon-Carbon Composite Brakes Using MSC.Marc. In M. Software (Ed.), Worldwide Aerospace Conference & Technology Showcase, Apr. 8-10, 2002 in Toulouse (pp. Paper 2001-58). Warszawa, Poland: MSC Software.
ⁱ(Zbigniew Wolejsza, 2002)
ⁱⁱ(Skybrary)
ⁱⁱⁱ(Garrett, 2010)
^{vi}(Wikipedia)
^{v}(Wikipedia)
^{vi}(Wikipedia)
^{vii}(Chem spider)
^{viii}(VLADIMÍR VÍCHA)
^{ix}(ScienceLab.com, 2012)
^{x}(Cryotech, 2011)
^{xi}(American National Standards Institute, 2009)
^{xii}(Multiple, 2008)
^{xiii}(Electronic Code of Federal Regulations, 2012)
^{xiv}(Kingsley-Jones, 2007)
^{xv}(Hebborn, 2008)

1. An apparatus for self-propelling aircraft undercarriage components, comprising: at least one self-propelled aircraft undercarriage wheel; at least one drive means for propelling said undercarriage wheel; said drive means comprising a rotor; whereby said drive means utilizes the external airflow to propel the said wheel.

2. The apparatus of claim 1 wherein the rotor is coupled to the said wheel.

3. The apparatus of claim 2 wherein the rotor comprises a plurality of vanes shaped to propel the wheel by the airflow around aircraft undercarriage components of claim 1.

4. The apparatus of claim 3 wherein the wheel rotates before and on the touch down in the desired direction to minimize the generation of heat on touch-down.

5. An apparatus for cooling a brake system, comprising: at least one moving member, one static member wherein the heat generated during breaking action is absorbed and dissipated by cooling means other than the air, called “coolant” hereinafter.

6. The apparatus of claim 5 wherein said coolant comprises additional substances such as solid particles, corrosion inhibitors, anti-freezing agents—mixed at variable, time-depending rates.

7. The apparatus of claim 5 or of claim 6, wherein said coolant is delivered to the heat-generating zone through a fluid conveyance such as but not limited to a tube, a pipe, or a hose.

8. The apparatus of claim 5, or of claim 6, wherein the delivery of the coolant is accomplished by gravity, by a pump (mechanical, diffusion, etc.), or by an air-flow driven turbine.

9. The apparatus of claim 5, or of claim 6, wherein the spent coolant is released from the heat-generating zone through at least one opening.

10. The apparatus of claim 5, or of claim 6, which is embodied in, or used in, but not limited to: an aircraft undercarriage, automotive vehicle, rail train, armored tank, elevator, winch, magnetic levitation vehicle (maglev) or any mechanical breaking system.

11. The apparatus of claim 5, or of claim 6, wherein the delivery of coolant commences after the temperature of the hot members of the apparatus reaches or exceeds a threshold.

12. The apparatus of claim 5, or of claim 6, wherein the delivery of coolant is controlled by an automatic control system with manual override.

13. The apparatus of claim 5, or of claim 6, wherein the coolant is embodied as but not limited to: the potable water, lavatories' liquid; helium; emulsion or a multi-phase mixture.

14. The apparatus of claim 12 wherein the automatic control system is programmed for the achieving an optimal or near to optimal goal such as but not limited to: stopping at the shortest distance, with such boundary conditions as the available coolant quantity, accounting for dependence of friction coefficient on temperature, external air temperature, specific heat values of coolant phases (liquid/gas/solid particles), and other parameters.
